(19) United States
(12) Patent Application Publication
(10) Pub. No.: US 2022/0245313 A1
(43) Pub. Date: Aug. 4, 2022

(54) METHOD FOR CALCULATING FLUID-STRUCTURE INTERACTION RESPONSE OF CERAMIC MATRIX COMPOSITES

(71) Applicant: NANJING UNIVERSITY OF AERONAUTICS AND ASTRONAUTICS, Nanjing (CN)

(72) Inventors: Yingdong SONG, Nanjing (CN); Xiguang GAO, Nanjing (CN); Guoqiang YU, Nanjing (CN); Dong HAN, Nanjing (CN); Sheng ZHANG, Nanjing (CN); Lu ZHANG, Nanjing (CN); Chao YOU, Nanjing (CN)

(21) Appl. No.: 17/431,412

(22) PCT Filed: Aug. 31, 2020
(86) PCT No.: PCT/CN2020/112600

§ 371 Date: Aug. 16, 2021

(30) Foreign Application Priority Data
Oct. 24, 2019 (CN) 201911020077.4

(51) Int. Cl. G06F 30/28; G06F 30/23

(52) U.S. Cl. CPC G06F 30/28; G06F 2113/08; G06F 30/23

(57) ABSTRACT

Disclosed is a method for calculating a fluid-structure interaction response of ceramic matrix composites (CMCs). The method includes: calculating a stress-strain hysteresis curve under loading and unloading of a CMC unit cell model through a multi-scale method; performing an interpolation to calculate a hysteresis loop response under arbitrary loading and unloading through a hysteresis loop under loading and unloading calculated through the unit cell model, and using the hysteresis loop response as a proxy model for a dynamics calculation of a solid domain of a fluid-structure interaction; and calculating a fluid load on a fluid-structure interaction interface through CFD, writing a program to read the fluid load and map the same to a solid node, reading a displacement of the solid node and mapping the same onto the fluid node, where a fluid domain and the solid domain use the same time step.

### CROSS REFERENCE TO RELATED APPLICATION

The present disclosure claims the priority of the Chinese Patent Application No. 201911020077.4, filed to the China National Intellectual Property Administration (CNIPA) on Oct. 24, 2019, and entitled “METHOD FOR CALCULATING FLUID-STRUCTURE INTERACTION RESPONSE OF CERAMIC MATRIX COMPOSITES”, which is incorporated herein by reference in its entirety.

### TECHNICAL FIELD

The present disclosure relates to the field of calculating a fluid-structure interaction response of woven ceramic matrix composites (CMCs), and in particular to a method for calculating a fluid-structure interaction response of CMCs.

### BACKGROUND ART

Woven CMCs show high specific strength, desirable specific modulus, and corrosion resistance at high temperature, and are thus an ideal material for manufacturing a high-temperature structure. When the CMCs are under load, they will crack even under a very small strain due to brittleness of a ceramic matrix. Therefore, the CMCs are usually in a nonlinear stage in engineering applications. The CMCs will show complex variable stiffness and a hysteresis under continuous loading and unloading during vibration. A CMC structure usually works in a severe environment, and is also subjected to a fluid-structure interaction (FSI), which is sometimes even a main factor leading to structural failure. Therefore, it is necessary to develop a method for calculating a fluid-structure interaction response of the CMC structure.

At present, a weak coupling solution method can make the best use of an existing solution program for a solid domain and a fluid domain, and thus has been widely used in engineering. However, it is rare to consider variable stiffness and a hysteresis behavior of a material under loading and unloading in a fluid-structure interaction simulation currently. For example, in Chinese Patent CN 103177162 B entitled “Thin-wall structure dynamics thermal performance prediction method based on staggering iteration coupling technology”, a method for calculating a fluid-structure interaction response of a thin wall is disclosed. In this patent, a solid domain is calculated through the Newmark method, in which nonlinearity of a material is not considered. In a calculation of a fluid-structure interaction of a cropped delta wing (Cui Peng, Han Jinglong. Aeroelastic simulation of limit cycle oscillation of cropped delta wing [J]. Chinese Journal of Aeronautics, 2010, 31(12): 2295-2301), nonlinearity of a material is considered in a solid domain, and the Newmark method is used to calculate a dynamic response, but a hysteresis behavior of the material is not taken into account.

In the foregoing patents and papers related to a fluid-structure interaction, the hysteresis behavior of the material is not considered in the solid domain at all. This is because in the engineering application, a designer usually ensures that the material generally works in its linear stage, and even in a nonlinear stage, the hysteresis behavior of a metal material is negligible. However, in the engineering applications of the CMCs, the variable stiffness and hysteresis behavior of the CMCs cannot be ignored. In the vibration process, the CMCs are virtually subjected to arbitrary loading or unloading. In the case of arbitrary loading and unloading, a method for calculating a stress-strain of CMCs, for example, a method for calculating a constitutive response under arbitrary loading and unloading disclosed in “Method for predicating stress-strain behavior under arbitrary loading and unloading of one-way ceramic matrix composite” (Chinese Patent CN 104866690 B), needs repeated iterations, so it is not suitable for a dynamic calculation. In a dynamic simulation method for ceramic matrix composites, for example, a method for determining a vibration response of ceramic matrix composites disclosed in “method for determining nonlinear vibration response of ceramic matrix composites” (Chinese Patent CN 106777595 B) greatly reduces the computation load compared with a previous method, and can be used for the dynamic calculation. However, in this patent, the calculation amount is still large when a sub-hysteresis loop is calculated, and large errors are accumulated under multiple loading and unloading, so that robustness of the dynamic calculation is poor. In addition, an introduction of the variable stiffness and a constitutive hysteresis model also brings a great challenge to a solution of a dynamic equation. Because of a sudden change of stiffness under loading and unloading, a discontinuity point is introduced, which leads to non-convergence of a calculation result of the dynamic equation.

Therefore, at present, a calculation of the fluid-structure interaction of the CMCs still has the following problems: (1) there is no efficient constitutive model for describing the variable stiffness and hysteresis behavior of the material in the solid domain; and (2) the dynamic equation of the solid domain considering the variable stiffness and hysteresis behavior of the material is to be solved.

### SUMMARY

The present disclosure aims to provide a method for calculating a fluid-structure interaction response of ceramic matrix composites.

In order to achieve the above-mentioned objective, a technical solution of the present disclosure is as follows:

a method for calculating a fluid-structure interaction response of ceramic matrix composites includes:

establishing a finite element model of a representative volume element of woven CMCs, and assigning an appropriate meso-mechanical model for a fiber bundle;

calculating a hysteresis loop under loading and unloading of the finite element model of the representative volume element of the woven CMCs, and performing an interpolation to calculate a hysteresis loop response under arbitrary loading and unloading, to obtain a method for calculating a stress-strain under arbitrary loading and unloading;

calculating a fluid load on a fluid-structure interaction interface through computational fluid dynamics (CFD), reading the fluid load, mapping the same onto a solid node, and performing a calculation to obtain a solid node load;

obtaining a fluid-structure interaction dynamic response of a CMC structure of a current time step based on the method for calculating the stress-strain under arbitrary loading and unloading and in combination with an explicit dynamic integration and the solid node load;

reading a displacement result of the solid node in the fluid-structure interaction dynamic response and mapping the same onto a fluid node, to obtain a displacement result of the fluid node on the interaction interface, wherein a fluid domain and a solid domain use the same time step; and

updating a position of the fluid node according to the displacement result of the fluid node on the interaction interface, proceeding to the step of “calculating a fluid load on a fluid-structure interaction interface through computational fluid dynamics (CFD), reading the fluid load, mapping the same onto a solid node, and performing a calculation to obtain a solid node load”, and calculating a fluid-structure interaction dynamic response of the CMC structure in the next time step.

Optionally, the calculating a hysteresis loop under loading and unloading of the finite element model of the representative volume element of the woven CMCs, and performing an interpolation to calculate a hysteresis loop response under arbitrary loading and unloading, to obtain a method for calculating a stress-strain under arbitrary loading and unloading particularly include:

assigning a series of loading and unloading paths for the finite element model of the representative volume element of the woven CMCs, wherein a maximum strain is gradually increased in a loading and unloading process, to obtain hysteresis loops corresponding to different maximum strains.

Optionally, the calculating a hysteresis loop under loading and unloading of the finite element model of the representative volume element of the woven CMCs, and performing an interpolation to calculate a hysteresis loop response under arbitrary loading and unloading, to obtain a method for calculating a stress-strain under arbitrary loading and unloading particularly include:

fitting the hysteresis loop by utilizing a cubic polynomial, to obtain a polynomial coefficient aₙ,bₙ(n=1 ˜4) corresponding to different E through fitting:

$$\{ \begin{matrix}{σ}^{+} = {\sum }_{n = 1}^{4} {a}_{n}^{{ɛ}_{i}} {ɛ}^{n - 1} \\ {σ}^{-} = {\sum }_{n = 1}^{4} {b}_{n}^{{ɛ}_{i}} {ɛ}^{n - 1}\end{matrix}$$

[20]

wherein σ denotes a stress, ε denotes the strain, εᵢ denotes a maximum strain of the i-th hysteresis loop, and + and − denote loading and unloading respectively;

for any maximum strain εₜ, when the maximum strain is between maximum strains calculated through finite element models of any two representative volume elements, that is, (εᵢ<εₜ<εᵢ₊₁), a polynomial coefficient of a current hysteresis loop is interpolated as follows: and

$$\{ \begin{matrix}{a}_{n}^{{ɛ}_{t}} = \frac{{ɛ}_{i + 1} - {ɛ}_{t}}{{ɛ}_{1 + 1} - ɛ ,} {a}_{n}^{{ɛ}_{i}} + \frac{{ɛ}_{t} - {ɛ}_{i}}{{ɛ}_{1 + 1} - ɛ ,} {a}_{n}^{{ɛ}_{i + 1}} \\ {b}_{n}^{{ɛ}_{t}} = \frac{{ɛ}_{i + 1} - {ɛ}_{t}}{{ɛ}_{i + 1} - {ɛ}_{i}} {b}_{n}^{{ɛ}_{i}} + \frac{{ɛ}_{t} - {ɛ}_{i}}{{ɛ}_{i + 1} - {ɛ}_{i}} {b}_{n}^{{ɛ}_{i + 1}}\end{matrix} , \\ ( n = 1 ∼ 4 )$$

when an amplitude changes from large to small, and loading and unloading occur inside a maximum hysteresis loop, assuming that a current stress-strain state is at a point P, and a position of the point P is (εₚ,σₚ), a displacement at the next moment is obtained through a dynamic numerical calculation, then a corresponding strain ε_{p′} is determined, and at the moment, a stress a at a point σ_{P′} at the next moment is calculated through the following equation:

$$\{ \begin{matrix}{σ}_{P ′}^{+} = {σ}_{P} + \frac{( {σ}_{B} - {σ}_{P} ) ( {a}_{2}^{{ɛ}_{t}} + 2 {a}_{3}^{{ɛ}_{t}} {ɛ}_{P} + 3 {a}_{4}^{{ɛ}_{t}} {ɛ}_{P}^{2} ) ( {ɛ}_{{P}^{′}} - {ɛ}_{P} )}{{σ}_{B} - ( {a}_{1}^{{ɛ}_{t}} + {a}_{2}^{{ɛ}_{t}} {ɛ}_{P} + {a}_{3}^{{ɛ}_{t}} {ɛ}_{P}^{2} + {a}_{4}^{{ɛ}_{t}} {ɛ}_{P}^{3} )} \\ {σ}_{P ′}^{-} = {σ}_{P} + \frac{( {σ}_{A} - {σ}_{P} ) ( {b}_{2}^{{ɛ}_{t}} + 2 {b}_{3}^{{ɛ}_{t}} {ɛ}_{P} + 3 {b}_{4}^{{ɛ}_{t}} {ɛ}_{P}^{2} ) ( {ɛ}_{{P}^{′}} - {ɛ}_{P} )}{{σ}_{A} - ( {b}_{1}^{{ɛ}_{t}} + {b}_{2}^{{ɛ}_{t}} {ɛ}_{P} + {b}_{3}^{{ɛ}_{t}} {ɛ}_{P}^{2} + {b}_{4}^{{ɛ}_{t}} {ɛ}_{P}^{3} )}\end{matrix}$$

where A and B denote upper and lower vertices of the hysteresis loop respectively.

Optionally, the calculating a fluid load on a fluid-structure interaction interface through computational fluid dynamics (CFD), reading the fluid load, mapping the same onto a solid node, and performing a calculation to obtain a solid node load comprise: solving the fluid domain through the CFD, to obtain geometric information and load information of a fluid element on the fluid-structure interaction interface.

Optionally, the calculating a fluid load on a fluid-structure interaction interface through computational fluid dynamics (CFD), reading the fluid load, mapping the same onto a solid node, and performing a calculation to obtain a solid node load include:

pairing solid elements and fluid elements, wherein each solid element corresponds to n fluid nodes; and

determining mapping of the fluid load onto the solid node through the following equation:

$${F}_{si} = {\sum }_{k = 1}^{n} {N}_{i}^{k} {F}_{f}^{k} ( i = 1 \sim 4 )$$

wherein S denotes a solid, f denotes a fluid, Fₛᵢ denotes an equivalent fluid load acting on the i-th node of any solid element, Nᵢ^{k} denotes a corresponding isoparametric interpolation coefficient during mapping an acting force of the k-th fluid element onto the i-th solid node, the isoparametric interpolation coefficient is calculated through the Newton iteration method, and F_{f}^{k} denotes an acting force, on a current solid element, of the k-th fluid element.

Optionally, the reading a displacement result of the solid node in the fluid-structure interaction dynamic response and mapping the same onto a fluid node, to obtain a displacement result of the fluid node on the interaction interface include:

matching any surface of each solid element with n fluid nodes in the surface; and

determining mapping of a displacement of the solid node onto the fluid node through the following equation:

$${u}_{f j} = {\sum }_{i = 1}^{4} {N}_{i}^{j} {u}_{s i}$$

where u_{fj} denotes a displacement of the j-th fluid node on any fluid element, Nᵢ^{j} denotes a corresponding isoparametric interpolation coefficient during mapping a displacement of the i-th solid node of the solid element onto the j-th fluid node, the isoparametric interpolation coefficient is calculated through the Newton iteration method, and uₛᵢ, denotes a displacement of the i-th solid node.

Compared with the prior art, the method for calculating a fluid-structure interaction response of ceramic matrix composites provided by the present disclosure has the advantages that the fluid-structure interaction response of the CMCs is calculated, variable stiffness and a hysteresis behavior of the CMCs under loading and unloading can be simply described and obtained, and a dynamic solution has good robustness and is not prone to divergence.

### BRIEF DESCRIPTION OF THE DRAWINGS

The present disclosure will be further described below with reference to the accompanying drawings:

FIG. 1 is a schematic diagram of stress-strain curves of an interpolated hysteresis loop in an embodiment of the present disclosure;

FIG. 2 is a schematic diagram of a stress and a strain under unloading in a hysteresis loop in an embodiment of the present disclosure;

FIG. 3 is a schematic diagram of a stress and a strain under loading in a hysteresis loop in an embodiment of the present disclosure;

FIG. 4 is a schematic diagram of mapping of a fluid load in an embodiment of the present disclosure; and

FIG. 5 is a schematic diagram of a fluid-structure interaction displacement response in an embodiment of the present disclosure.

### DETAILED DESCRIPTION OF THE EMBODIMENTS

The present disclosure is described in more detail below with reference to the accompanying drawings.

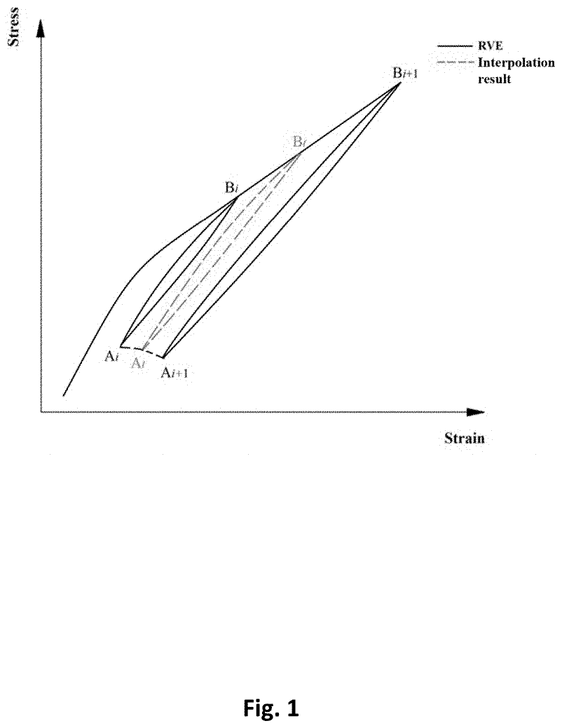

As shown in FIGS. 1-5, the present disclosure provides a method for calculating a fluid-structure interaction response of ceramic matrix composites. The method includes: calculating a stress-strain hysteresis curve under loading and unloading of a CMC unit cell model through a multi-scale method; performing an interpolation to calculate a hysteresis loop response under arbitrary loading and unloading through a hysteresis loop under loading and unloading calculated through the unit cell model, and using the hysteresis loop response as a proxy model for a dynamic calculation of a solid domain of a fluid-structure interaction; and calculating a fluid load on a fluid-structure interaction interface through CFD, writing a program to read the fluid load and map the same to a solid node, reading a displacement of the solid node and mapping the same onto the fluid node, where a fluid domain and the solid domain use the same time step.

Firstly, a finite element model of a representative volume element (RVE) of woven CMCs is established, a self-defined meso-mechanical model may be added in the RVE model, and a strain under loading and unloading is assigned, to obtain a constitutive response curve under loading and unloading. In the dynamic calculation, it is very time-consuming to directly use the RVE model for a calculation. Therefore, a series of hysteresis loops under loading and unloading are calculated through the RVE model first, and in the dynamic calculation, an interpolation calculation is carried out among a series of hysteresis loops calculated before. As shown in FIG. 1, since a nonlinear hysteresis behavior of the CMCs is closely related to a maximum strain εₘₐₓ, and a peak position and a curve shape of each hysteresis loop are determined by εₘₐₓ, which can be obtained through numerical fitting. The ith hysteresis loop calculated through the RVE model includes loading and unloading sections, and can be fitted into the following polynomial:

$$\{ \begin{matrix}{σ}^{+} = {\sum }_{n = 1}^{4} {a}_{n}^{{ɛ}_{i}} {ɛ}^{n - 1} \\ {σ}^{-} = {\sum }_{n = 1}^{4} {b}_{n}^{{ɛ}_{i}} {ɛ}^{n - 1}\end{matrix}$$

where σ denotes a stress, ε denotes the strain, εᵢ denotes a maximum strain of the i-th hysteresis loop, + and − denote loading and unloading respectively, and a polynomial coefficient may be expressed in the following form:

$$\{ \begin{matrix}{a}_{n}^{ɛ ,} = f ( ɛ , ) \\ {b}_{n}^{ɛ ,} = f ( ɛ , ) \end{matrix} , ( n = 1 ∼ 4 )$$

where f(εᵢ) denotes a function related to εᵢ.

In a dynamic calculation process, a current maximum hysteresis loop is calculated first, and if a maximum strain of the current hysteresis loop is εₜ, which is between and maximum strains εᵢ and εᵢ₊₁ corresponding to the hysteresis loops calculated through the RVE model, the polynomial coefficient of the current hysteresis loop may be expressed as:

$$\{ \begin{matrix}{a}_{n}^{{ɛ}_{t}} = \frac{{ɛ}_{i + 1} - {ɛ}_{t}}{{ɛ}_{i + 1} - {ɛ}_{i}} {a}_{n}^{{ɛ}_{i}} + \frac{{ɛ}_{t} - {ɛ}_{i}}{{ɛ}_{i + 1} - {ɛ}_{i}} {a}_{n}^{{ɛ}_{i + 1}} \\ {b}_{n}^{{ɛ}_{t}} = \frac{{ɛ}_{i + 1} - {ɛ}_{t}}{{ɛ}_{i + 1} - {ɛ}_{i}} {b}_{n}^{{ɛ}_{i}} + \frac{{ɛ}_{t} - {ɛ}_{i}}{{ɛ}_{i + 1} {ɛ}_{i}} {b}_{n}^{{ɛ}_{i + 1}}\end{matrix} , ( n = 1 ∼ 4 )$$

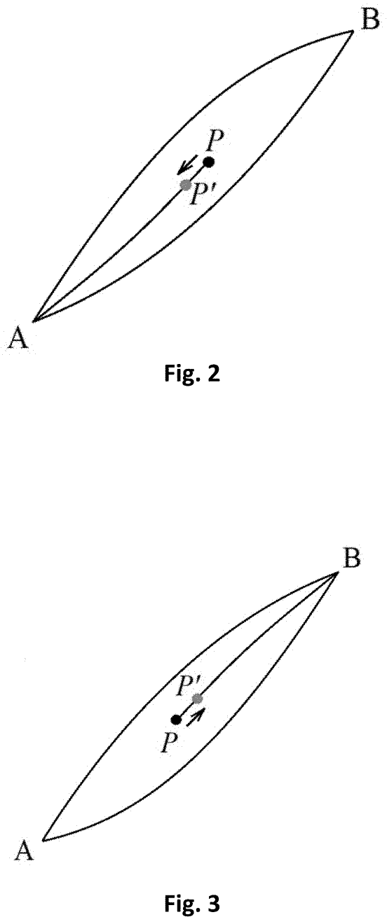

When an amplitude changes from large to small, it is necessary to perform an interpolation in the hysteresis loop, as shown in FIGS. 2-3, assuming that a current stress-strain state is at a point P, and its position is (εₚ,σₚ). A displacement at the next moment is obtained through a dynamic numerical calculation, then a corresponding strain ε_{P′} can be determined, and at the moment, a stress σ_{p′} at a point P′ at the next moment is calculated through the following equation:

$$\{ \begin{matrix}{σ}_{{P}^{′}}^{+} = {σ}_{P} + \frac{( {σ}_{B} - {σ}_{P} ) ( {a}_{2}^{{ɛ}_{t}} + 2 {a}_{3}^{{ɛ}_{t}} {ɛ}_{P} + 3 {a}_{4}^{{ɛ}_{t}} {ɛ}_{P}^{2} ) ( {ɛ}_{{P}^{′}} - {ɛ}_{P} )}{{σ}_{B} - ( {a}_{1}^{{ɛ}_{t}} + {a}_{2}^{{ɛ}_{t}} {ɛ}_{P} + {a}_{3}^{{ɛ}_{t}} {ɛ}_{P}^{2} + {a}_{4}^{{ɛ}_{t}} {ɛ}_{P}^{3} )} \\ {σ}_{{P}^{′}}^{-} = {σ}_{P} + \frac{( {σ}_{A} - {σ}_{P} ) ( {b}_{2}^{{ɛ}_{t}} + 2 {b}_{3}^{{ɛ}_{t}} {ɛ}_{P} + 3 {b}_{4}^{{ɛ}_{t}} {ɛ}_{P}^{2} ) ( {ɛ}_{{P}^{′}} - {ɛ}_{P} )}{{σ}_{A} - ( {b}_{1}^{{ɛ}_{t}} + {b}_{2}^{{ɛ}_{t}} {ɛ}_{P} + {b}_{3}^{{ɛ}_{t}} {ɛ}_{P}^{2} + {b}_{4}^{{ɛ}_{t}} {ɛ}_{P}^{3} )}\end{matrix}$$

where A and B denote upper and lower vertices of the hysteresis loop respectively.

A stress-strain response of the woven CMCs under arbitrary loading and unloading can be calculated through the above process, and is applied to a nonlinear dynamic calculation of the CMCs.

In a fluid-structure interaction calculation, if a dynamic solution method requiring an iteration such as Newmark is used in the solid domain, variable stiffness and a hysteresis behavior of the CMCs will cause a stiffness discontinuity during loading and unloading, which will bring a difficulty to the dynamic solution. In the present patent, an explicit integration method such as a central difference method is used to calculate a vibration response, so as to avoid iterating a constitutive model under loading and unloading, and avoid a divergence of a solution result.

Interface mapping of the fluid-structure interaction includes load mapping and displacement mapping. Load mapping is to map a fluid acting force onto a solid finite element node prior to a dynamic calculation of each time step. After a displacement is obtained through the dynamic calculation, displacement mapping is to map the displacement onto the fluid node.

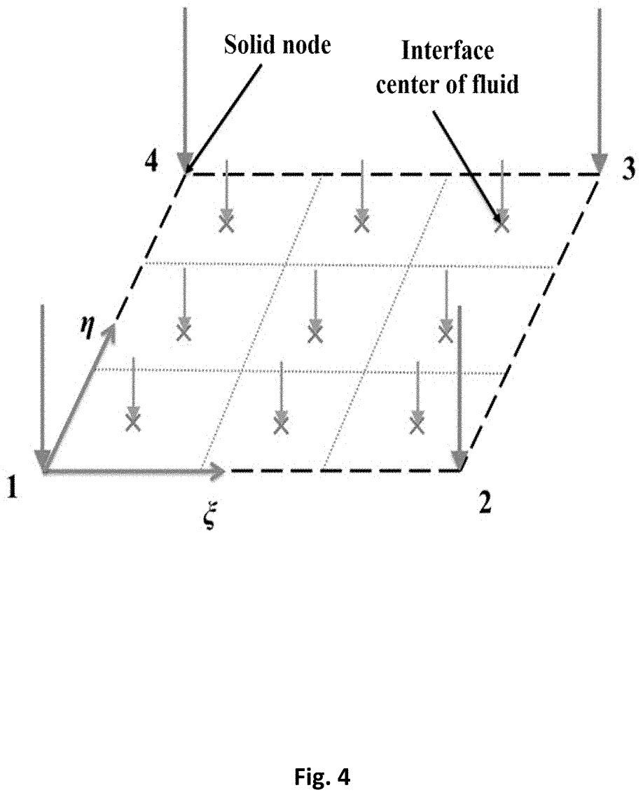

As shown in FIG. 4, fluid load mapping includes reading interface center coordinates of an element of each interaction interface and a magnitude of an acting force at the moment first. Since grids of the solid domain do not match grids of the fluid domain, the grids of the fluid domain are usually much denser than those of the solid domain on the interaction interface, and it is necessary to map the fluid load onto the solid nodes. If there are n fluid nodes in certain interacted element surface, a force acting on the solid node is expressed as:

$${F}_{s i} = {\sum }_{k = 1}^{n} {N}_{i}^{k} {F}_{f}^{k} ( i = 1 \sim 4 )$$

where S denotes a solid, f denotes a fluid, Fₛᵢ, denotes an equivalent fluid load acting on the i-th node of certain solid element, Nᵢ^{k}denotes a corresponding isoparametric interpolation coefficient during mapping an acting force of the k-th fluid element onto the i-th solid node, and F_{f}^{k} denotes an acting force, on a current solid element, of the k-th fluid element.

For the isoparametric interpolation coefficient, it is necessary to calculate parameter coordinates of the fluid node in the solid element, and the isoparametric interpolation coefficient can be calculated through a numerical method such as the Newton iteration method.

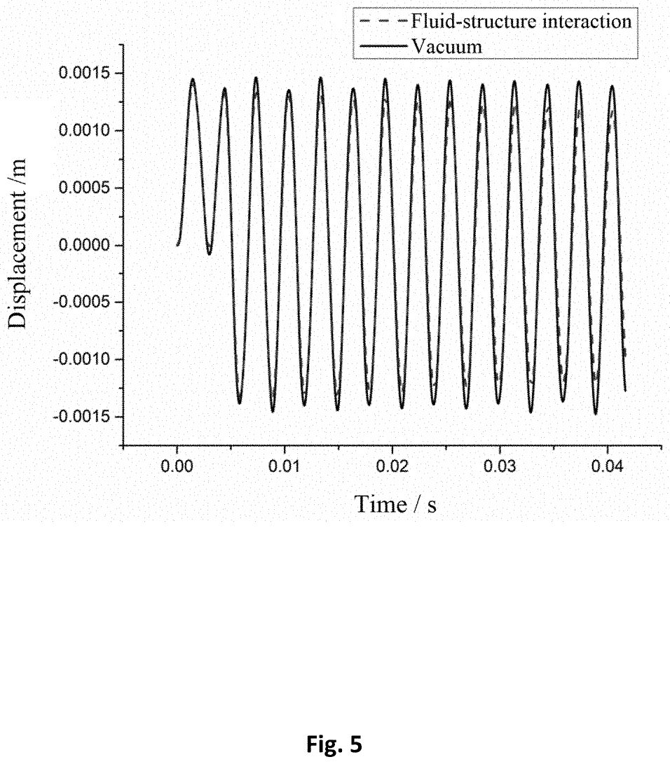

As shown in FIG. 5, displacement mapping is similar to fluid load mapping and can be expressed as:

$${u}_{f j} = {\sum }_{i = 1}^{4} {N}_{i}^{j} {u}_{s i}$$

where u_{fj}, denotes a displacement of the j-th fluid node on any fluid element, Nᵢ^{j} denotes a corresponding isoparametric interpolation coefficient during mapping a displacement of the i-th solid node of the solid element onto the j-th fluid node, the isoparametric interpolation coefficient is calculated through the Newton iteration method, and uₛᵢ denotes a displacement of the i-th solid node.

Next, the method for calculating the fluid-structure interaction response of the ceramic matrix composites is specifically described in combination with a specific embodiment, and the method includes the following steps.

S1: establishing a finite element model of a representative volume element of woven CMCs, and assigning an appropriate meso-mechanical model for a fiber bundle.

S2: assigning a series of loading and unloading paths for the finite element model of the representative volume element, where a maximum strain shall be gradually increased during loading and unloading, to obtain hysteresis loops corresponding to different maximum strains, and the more hysteresis loops are obtained, the more accurate a calculation result will be. It should be noted that during unloading, unloading shall be carried out until a crack is closed. In other words, if unloading is continued, the stress-strain relationship becomes linear.

S3: fitting these hysteresis loops by utilizing a cubic polynomial to obtain sufficient accuracy, since convexity and concavity of each hysteresis loop usually change at most once, where a polynomial coefficient aₙ,bₙ(n=1-4) corresponding to different εᵢ obtained through fitting is as follows:

$$\{ \begin{matrix}{σ}^{+} = {\sum }_{n = 1}^{4} {a}_{n}^{{ɛ}_{i}} {ɛ}^{n - 1} \\ {σ}^{-} = {\sum }_{n = 1}^{4} {b}_{n}^{{ɛ}_{i}} {ɛ}^{n - 1}\end{matrix} .$$

S4: when any maximum strain Eₜ is between maximum strains calculated through certain two RVE models, that is, (εᵢ<εₜ<εᵢ₊ₜ), performing an interpolation on a polynomial coefficient of a current hysteresis loop as follows:

$$\{ \begin{matrix}{a}_{n}^{{ɛ}_{t}} = \frac{{ɛ}_{i + 1} - {ɛ}_{t}}{{ɛ}_{i + 1} - {ɛ}_{i}} {a}_{n}^{{ɛ}_{i}} + \frac{{ɛ}_{t} - {ɛ}_{i}}{{ɛ}_{i + 1} - {ɛ}_{i}} {a}_{n}^{{ɛ}_{i + 1}} \\ {b}_{n}^{{ɛ}_{t}} = \frac{{ɛ}_{i + 1} - {ɛ}_{t}}{{ɛ}_{i + 1} - {ɛ}_{i}} {b}_{n}^{{ɛ}_{i}} + \frac{{ɛ}_{t} - {ɛ}_{i}}{{ɛ}_{i + 1} - {ɛ}_{i}} {b}_{n}^{{ɛ}_{i + 1}}\end{matrix} , ( n = 1 - 4 ) .$$

S5: when an amplitude changes from large to small, and loading and unloading occur inside a maximum hysteresis loop, on the basis of knowing a current stress-strain, obtaining a stress at the next moment through the following equation:

$$\{ \begin{matrix}{σ}_{{P}^{′}}^{+} = {σ}_{P} + \frac{( {σ}_{B} - {σ}_{P} ) ( {a}_{2}^{{ɛ}_{t}} + 2 {a}_{3}^{{ɛ}_{t}} {ɛ}_{P} + 3 {a}_{4}^{{ɛ}_{t}} {ɛ}_{P}^{2} ) ( {ɛ}_{{P}^{′}} - {ɛ}_{P} )}{{σ}_{B} - ( {a}_{1}^{{ɛ}_{t}} + {a}_{2}^{{ɛ}_{t}} {ɛ}_{P} + {a}_{3}^{{ɛ}_{t}} {ɛ}_{P}^{2} + {a}_{4}^{{ɛ}_{t}} {ɛ}_{P}^{3} )} \\ {σ}_{{P}^{′}}^{-} = {σ}_{P} + \frac{( {σ}_{A} - {σ}_{P} ) ( {b}_{2}^{{ɛ}_{t}} + 2 {b}_{3}^{{ɛ}_{t}} {ɛ}_{P} + 3 {b}_{4}^{{ɛ}_{t}} {ɛ}_{P}^{2} ) ( {ɛ}_{{P}^{′}} - {ɛ}_{P} )}{{σ}_{A} - ( {b}_{1}^{{ɛ}_{t}} + {b}_{2}^{{ɛ}_{t}} {ɛ}_{P} + {b}_{3}^{{ɛ}_{t}} {ɛ}_{P}^{2} + {b}_{4}^{{ɛ}_{t}} {ɛ}_{P}^{3} )}\end{matrix} .$$

S7: pairing solid elements and fluid elements, where fluid grids are usually much denser than solid grids, and each solid element corresponds to n fluid nodes; and mapping a fluid load onto a solid node through the following equation, where an isoparametric interpolation coefficient can be calculated through the Newton iteration method on the basis of knowing interface center coordinates of a fluid and four solid node coordinates:

$${F}_{s i} = {\sum }_{k = 1}^{n} {N}_{i}^{k} {F}_{f}^{k} ( i = 1 - 4 ) .$$

S8: solving a fluid-structure interaction dynamic response of a CMC structure at a current time step based on the above-mentioned method for calculating the stress-strain under arbitrary loading and unloading, and in combination with the explicit dynamic integration, where a solid node load is calculated in S7.

S9: mapping a displacement of the solid node onto the fluid node of an interaction interface according to a displacement result of the solid node calculated in S8, where displacement mapping of the solid node also matches certain surface of each solid element and n fluid nodes in the surface, and the displacement of the solid node is mapped to the fluid node through the following equation, where similar to the previous step, an isoparametric interpolation coefficient is calculated through the Newton iteration method;

$${u}_{f j} = {\sum }_{i = 1}^{4} {N}_{i}^{j} {u}_{s i}$$

S10, updating a flow field node position according to a displacement result of the fluid node of the interaction interface calculated in S9, and performing a calculation of the next interaction step, that is, proceeding to S6.

It should be noted that, as used herein, terms such as “upper”, “lower”, “left”, “right”, “front” and “back” are merely employed for ease of a description, and not intended to limit the implementable scope of the present disclosure, and a change or adjustment of its relative relation shall also be deemed as falling within the implementable scope of the present disclosure without a substantial alteration of a technical content.

The above embodiments are provided merely for an objective of describing the present disclosure and are not intended to limit the scope of the present disclosure. The scope of the present disclosure is defined by the appended claims. Various equivalent replacements and modifications made without departing from the spirit and scope of the present disclosure should all fall within the scope of the present disclosure.

What is claimed is:

1. A method for calculating a fluid-structure interaction response of ceramic matrix composites (CMCs), comprising:
establishing a finite element model of a representative volume element of woven CMCs, and assigning an appropriate meso-mechanical model for a fiber bundle;
calculating a hysteresis loop under loading and unloading of the finite element model of the representative volume element of the woven CMCs, and performing an interpolation to calculate a hysteresis loop response under arbitrary loading and unloading, to obtain a method for calculating a stress-strain under arbitrary loading and unloading;
calculating a fluid load on a fluid-structure interaction interface through computational fluid dynamics (CFD), reading the fluid load, mapping the same onto a solid node, and performing a calculation to obtain a solid node load;
obtaining a fluid-structure interaction dynamic response of a CMC structure of a current time step based on the method for calculating the stress-strain under arbitrary loading and unloading and in combination with an explicit dynamic integration and the solid node load;
reading a displacement result of the solid node in the fluid-structure interaction dynamic response and mapping the same onto a fluid node, to obtain a displacement result of the fluid node on the interaction interface, wherein a fluid domain and a solid domain use the same time step; and
updating a position of the fluid node according to the displacement result of the fluid node on the interaction interface, proceeding to the step of “calculating a fluid load on a fluid-structure interaction interface through computational fluid dynamics (CFD), reading the fluid load, mapping the same onto a solid node, and performing a calculation to obtain a solid node load”, and calculating a fluid-structure interaction dynamic response of the CMC structure in the next time step.

2. The method for calculating a fluid-structure interaction response of ceramic matrix composites according to claim 1, wherein the calculating a hysteresis loop under loading and unloading of the finite element model of the representative volume element of the woven CMCs, and performing an interpolation to calculate a hysteresis loop response under arbitrary loading and unloading, to obtain a method for calculating a stress-strain under arbitrary loading and unloading comprise:
assigning a series of loading and unloading paths for the finite element model of the representative volume element of the woven CMCs, wherein a maximum strain is gradually increased in a loading and unloading process, to obtain hysteresis loops corresponding to different maximum strains.

3. The method for calculating a fluid-structure interaction response of ceramic matrix composites according to claim 1, wherein the calculating a hysteresis loop under loading and unloading of the finite element model of the representative volume element of the woven CMCs, and performing an interpolation to calculate a hysteresis loop response under arbitrary loading and unloading, to obtain a method for calculating a stress-strain under arbitrary loading and unloading comprise:
fitting the hysteresis loop by utilizing a cubic polynomial, to obtain a polynomial coefficient aₙ,bₙ(n=1 ˜4) corresponding to different εᵢ through fitting:
$$\{ \begin{matrix}{σ}^{+} = {\sum }_{n = 1}^{4} {a}_{n}^{{ɛ}_{i}} {ɛ}^{n - 1} \\ {σ}^{-} = {\sum }_{n = 1}^{4} {b}_{n}^{{ɛ}_{i}} {ɛ}^{n - 1}\end{matrix}$$
wherein σ denotes a stress, ε denotes the strain, εᵢ denotes a maximum strain of the i-th hysteresis loop, and + and − denote loading and unloading respectively;
for any maximum strain εₜ, when the maximum strain is between maximum strains calculated through finite element models of any two representative volume elements, that is, (εᵢ<εₜ<εᵢ₊ₜ), a polynomial coefficient of a current hysteresis loop is interpolated as follows:
$$\{ \begin{matrix}{a}_{n}^{{ɛ}_{t}} = \frac{{ɛ}_{i + 1} - {ɛ}_{t}}{{ɛ}_{i + 1} - {ɛ}_{i}} {a}_{n}^{{ɛ}_{i}} + \frac{{ɛ}_{t} - {ɛ}_{i}}{{ɛ}_{i + 1} - {ɛ}_{i}} {a}_{n}^{{ɛ}_{i + 1}} \\ {b}_{n}^{{ɛ}_{t}} = \frac{{ɛ}_{i + 1} - {ɛ}_{t}}{{ɛ}_{i + 1} - {ɛ}_{i}} {b}_{n}^{{ɛ}_{i}} + \frac{{ɛ}_{t} - {ɛ}_{i}}{{ɛ}_{i + 1} - {ɛ}_{i}} {b}_{n}^{{ɛ}_{i + 1}}\end{matrix} , ( n = 1 \sim 4 )$$
when an amplitude changes from large to small, and loading and unloading occur inside a maximum hysteresis loop, assuming that a current stress-strain state is at a point P, and a position of the point P is (εₚ,σₚ), a displacement at the next moment is obtained through a dynamic numerical calculation, then a corresponding strain ε_{P′} is determined, and at the moment, a stress σₚ, at a point P′ at the next moment is calculated through the following equations:
$$\{ \begin{matrix}{σ}_{{P}^{′}}^{+} = {σ}_{P} + \frac{( {σ}_{B} - {σ}_{P} ) ( {a}_{2}^{{ɛ}_{t}} + 2 {a}_{3}^{{ɛ}_{t}} {ɛ}_{P} + 3 {a}_{4}^{{ɛ}_{t}} {ɛ}_{P}^{2} ) ( {ɛ}_{{P}^{′}} - {ɛ}_{P} )}{{σ}_{B} - ( {a}_{1}^{{ɛ}_{t}} + {a}_{2}^{{ɛ}_{t}} {ɛ}_{P} + {a}_{3}^{{ɛ}_{t}} {ɛ}_{P}^{2} + {a}_{4}^{{ɛ}_{t}} {ɛ}_{P}^{3} )} \\ {σ}_{{P}^{′}}^{-} = {σ}_{P} + \frac{( {σ}_{A} - {σ}_{P} ) ( {b}_{2}^{{ɛ}_{t}} + 2 {b}_{3}^{{ɛ}_{t}} {ɛ}_{P} + 3 {b}_{4}^{{ɛ}_{t}} {ɛ}_{P}^{2} ) ( {ɛ}_{{P}^{′}} - {ɛ}_{P} )}{{σ}_{A} - ( {b}_{1}^{{ɛ}_{t}} + {b}_{2}^{{ɛ}_{t}} {ɛ}_{P} + {b}_{3}^{{ɛ}_{t}} {ɛ}_{P}^{2} + {b}_{4}^{{ɛ}_{t}} {ɛ}_{P}^{3} )}\end{matrix}$$
where A and B denote upper and lower vertices of the hysteresis loop respectively.

4. The method for calculating a fluid-structure interaction response of ceramic matrix composites according to claim 1, wherein the calculating a fluid load on a fluid-structure interaction interface through computational fluid dynamics (CFD), reading the fluid load, mapping the same onto a solid node, and performing a calculation to obtain a solid node load comprise: solving the fluid domain through the CFD, to obtain geometric information and load information of a fluid element on the fluid-structure interaction interface.

5. The method for calculating a fluid-structure interaction response of ceramic matrix composites according to claim 1, wherein the calculating a fluid load on a fluid-structure interaction interface through computational fluid dynamics (CFD), reading the fluid load, mapping the same onto a solid node, and performing a calculation to obtain a solid node load comprise:
pairing solid elements and fluid elements, wherein each solid element corresponds to n fluid nodes; and
determining mapping of the fluid load onto the solid node through the following equation:
$${F}_{s i} = {\sum }_{k = 1}^{n} {N}_{i}^{k} {F}_{f}^{k} ( i = 1 \sim 4 )$$
wherein s denotes a solid, f denotes a fluid, Fₛᵢ denotes an equivalent fluid load acting on the i-th node of any solid element, Nᵢ^{k} denotes a corresponding isoparametric interpolation coefficient during mapping an acting force of the k-th fluid element onto the i-th solid node, the isoparametric interpolation coefficient is calculated through the Newton iteration method, and F_{f}^{k} denotes an acting force, on a current solid element, of the k-th fluid element.

6. The method for calculating a fluid-structure interaction response of ceramic matrix composites according to claim 1, wherein the reading a displacement result of the solid node in the fluid-structure interaction dynamic response and mapping the same onto a fluid node, to obtain a displacement result of the fluid node on the interaction interface comprise:
matching any surface of each solid element with n fluid nodes in the surface; and
determining mapping of a displacement of the solid node onto the fluid node through the following equation:
$${u}_{f j} = {\sum }_{i = 1}^{4} {N}_{i}^{j} {u}_{s i}$$
where u_{fj} denotes a displacement of the j-th fluid node on any fluid element, Nᵢ^{j} denotes a corresponding isoparametric interpolation coefficient during mapping a displacement of the i-th solid node of the solid element onto the j-th fluid node, the isoparametric interpolation coefficient is calculated through the Newton iteration method, and uₛᵢ denotes a displacement of the i-th solid node.
